(19) United States
(12) Patent Application Publication
(10) Pub. No.: US 2024/0417121 A1
(43) Pub. Date: Dec. 19, 2024

(54) PULSED CONTROL FOR VIBRATING PARTICLE FEEDER

(71) Applicant: 6K Inc., North Andover, MA (US)

(72) Inventors: Michael Kozlowski, Reading, MA (US); David Hartung, Maynard, MA (US); Richard Malen, Tyngsboro, MA (US); John Colwell, Durham, NH (US)

(21) Appl. No.: 18/705,918

(22) PCT Filed: Oct. 24, 2022
(86) PCT No.: PCT/US2022/078607

§ 371 Date: Apr. 29, 2024

Related U.S. Application Data
(60) Provisional application No. 63/273,260, filed on Oct. 29, 2021.

(51) Int. Cl. B65B 37/04; B23K 10/02

(52) U.S. Cl. CPC B65B 37/04; B23K 10/02

(57) ABSTRACT

A pulsed control vibratory particle hopper includes a particle hopper, a vibrating tray, a mechanical vibrator, and a controller. The particle hopper includes a hopper outlet, and the vibrating tray receives particles from the hopper outlet. The mechanical vibrator is mechanically connected to the vibrating tray to generate a baseline vibration, as well as a periodic vibration amplitude spike or pulse. The controller is in communication with the mechanical vibrator to control the mechanical vibrator and generate the periodic vibration amplitude spike with a duration Tp, a maximum amplitude Ap, and a frequency Fp. The pulse duration, pulse amplitude, and pulse frequency are determined based on the size or a type of the material being dispensed from the particle hopper.

### CROSS REFERENCE TO RELATED APPLICATIONS

This application claims priority and benefit to U.S. Provisional Patent Application No. 63/273,260, filed Oct. 29, 2021, and entitled “Pulsed Control for Vibrating Particle Feeder”. The content of which is incorporated herein by reference in its entirety.

### FIELD OF THE INVENTION

The present technology generally relates to devices, systems, and methods for feeding small powder materials. In particular, the present technology relates to methods and systems for controlling feed rates of powder materials using a time-varying pulsed vibratory particle feeder.

### BACKGROUND

Plasma torches provide a high temperature plasma for a variety of purposes. In general, there are several types of plasma torches including induction plasma torches and microwave plasma torches. Other types of plasma torches can include direct current (DC) plasma, with arcing between a cathode and anode. These types of plasma torches provide substantially different high temperatures, with microwave plasma reaching about 6,000 K and the rest reaching about 10,000 K.

These high temperature plasmas may enable processing of a variety of materials that are exposed to or fed into the plasma. One such type of processing is taking one or more materials of a particular size and shape and, by exposing or feeding it into the plasma, changing the one or more materials into a different size and/or shape

### SUMMARY

Provided herein are devices and methods for pulsed control of a vibratory particle hopper. According to one aspect, the present disclosure relates to a pulsed control vibratory particle hopper, including: a particle hopper, a vibrating tray, a mechanical vibrator, and a controller. The particle hopper includes a hopper outlet with a parallel geometry, where the sidewalls of the hopper have a cross sectional geometry that is substantially parallel. The vibrating tray receives particles from the hopper outlet, and the mechanical vibrator is mechanically connected to the vibrating tray to generate a baseline vibration, as well as a periodic vibration amplitude spike. The controller is in communication with the mechanical vibrator to control the mechanical vibrator to generate the periodic vibration amplitude spike having a duration Tp, a maximum amplitude Ap, and a frequency Fp. The duration Tp, maximum amplitude Ap, and frequency Fp are determined based on a size or a type of a material being dispensed from the particle hopper. In one embodiment, the controller is programmed to generate a different periodic vibration amplitude spike when different materials are being dispensed.

According to another aspect, the present disclosure relates to a particle feeding system including a particle hopper with a hopper outlet, a vibrating tray to receive material from the hopper outlet, a mechanical vibrator, and a controller. The mechanical vibrator generates a vibration at a particular frequency and amplitude, and the controller is in communication with the mechanical vibrator to control the mechanical vibrator to generate periodic vibration amplitude spikes depending on the properties of the material being dispensed from the particle feeding system. In one embodiment, the hopper outlet has an inverted cross sectional geometry that increases in size toward an exit end of the hopper outlet. In one embodiment, the hopper outlet has a parallel cross sectional geometry with parallel sidewalls. In one embodiment, the material being dispensed from the particle feeding system includes particles having a diameter of about 5 microns or smaller. In one embodiment, the material being dispensed from the particle feeding system includes NMC battery cathode materials. In one embodiment, the controller causes the mechanical vibrator to generate periodic vibration amplitude spikes having a duration Tp depending on a size or a type of the material being dispensed from the particle feeding system. In one embodiment, the duration Tp of the periodic vibration amplitude spikes do not disrupt overall material feed rate. In one embodiment, the controller causes the mechanical vibrator to generate periodic vibration amplitude spikes having a maximum amplitude Ap depending on a size or a type of the material being dispensed from the particle feeding system. In one embodiment, the controller causes the mechanical vibrator to generate periodic vibration amplitude spikes having a frequency Fp depending on a size or a type of the material being dispensed from the particle feeding system.

According to another aspect of the present disclosure, a method for feeding particles is disclosed. The method includes: introducing particles into a particle hopper with a hopper outlet; providing the particles from the hopper outlet to a vibrating tray; generating a vibration at the vibrating tray at a particular frequency and amplitude using a mechanical vibrator; and generating periodic vibration amplitude spikes depending on the properties of a material being dispensed from the particle feeding system. In one embodiment, the hopper outlet has an inverted cross sectional geometry that increases in size toward an exit end of the hopper outlet. In one embodiment, the hopper outlet has a parallel cross sectional geometry with parallel sidewalls. In one embodiment, the particles introduced into the particle hopper have a diameter of about 5 microns or smaller. In one embodiment, the particles introduced into the particle hopper include NMC battery cathode materials. In one embodiment, the periodic vibration amplitude spikes have a duration Tp depending on a size or a type of the material being dispensed from the particle feeding system. In one embodiment, the duration Tp of the periodic vibration amplitude spikes do not disrupt overall material feed rate. In one embodiment, the periodic vibration amplitude spikes have a maximum amplitude Ap depending on a size or a type of the material being dispensed from the particle feeding system. In one embodiment, the periodic vibration amplitude spikes have a frequency Fp depending on a size or a type of the material being dispensed from the particle feeding system. In an embodiment, the method also includes providing the material being dispensed from the particle feeding system to a jet mill for further processing. In an embodiment, the method also includes providing the material being dispensed from the particle feeding system to a plasma torch for further processing.

The techniques disclosed herein may provide one or more of the following advantages. The techniques disclosed herein may allow for the feeding of small metal powders, as small as about 5 microns or smaller, in some embodiments. In some embodiments, the techniques disclosed herein facilitate the production of small metallic powders. The techniques disclosed herein also enable feeding of certain materials that may be sticky, such as small-particle nickel-manganese-cobolt (NMC) battery cathode materials, which may cause feeding problems in other systems.

### BRIEF DESCRIPTION OF THE DRAWINGS

The invention may be more fully understood from the following detailed description taken in conjunction with the accompanying drawings.

FIG. 1 shows an example system for dispensing particles, according to one embodiment of the present disclosure.

FIG. 2 shows another example system for dispensing particles, according to one embodiment of the present disclosure.

FIGS. 3A-3C show cross sectional views of example hopper geometries, according to one embodiment of the present disclosure.

FIG. 4 is a graph of example vibration spikes or pulses, according to one embodiment of the present disclosure.

FIG. 5 is a flow chart illustrating a method of dispensing particles, according to one embodiment of the present disclosure.

FIG. 6 is a block diagram of an example apparatus that may perform one or more of the operations described herein, according to one embodiment of the present disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

According to one embodiment, the system disclosed herein generates a baseline vibration, as well as a vibration pulse depending on the type and/or size of the particles being dispensed. The vibration pulse can have a particular pulse amplitude, duration, and frequency. Both the baseline vibration and the vibration pulse can have certain characteristics that depend on the type of particles being dispensed from the hopper (e.g. the chemical makeup of the particles), or based on the size or geometry of the particles (e.g. whether the particles are spherical or non-spherical, or the size or size distribution of the particles).

In some embodiments, the baseline vibration and/or the vibration pulses can be transmitted to a vibrating surface or channel, or to an exterior surface of the hopper itself, or both. This can be achieved, for example, using a vibrating motor or mechanical vibrator, which can generate vibrations at a particular amplitude and frequency. The baseline vibration and vibration pulses can be implemented using a controller, in some embodiments, which is in communication with the mechanical vibrator and can control the amplitude, duration, and frequency of the vibrations.

In some embodiments, in order to prevent bridging or rat-holing, the hopper can have a substantially parallel cross-sectional geometry, with the sidewalls of the hopper being generally parallel. In other embodiments, the hopper can have an inverted cross-sectional geometry where the hopper inlet has an opening that is smaller than the hopper outlet.

The particle feeding systems disclosed herein can be used, in some embodiments, to feed particles or powders into a jet mill or a plasma torch. For example, the vibrating surface or channel can direct particles to the inlet of a jet mill or a plasma torch, for further processing. One skilled in the art will recognize that the techniques disclosed herein can be used to feed particles or small powders to various types of jet mills or plasma torches, or other materials processing systems.

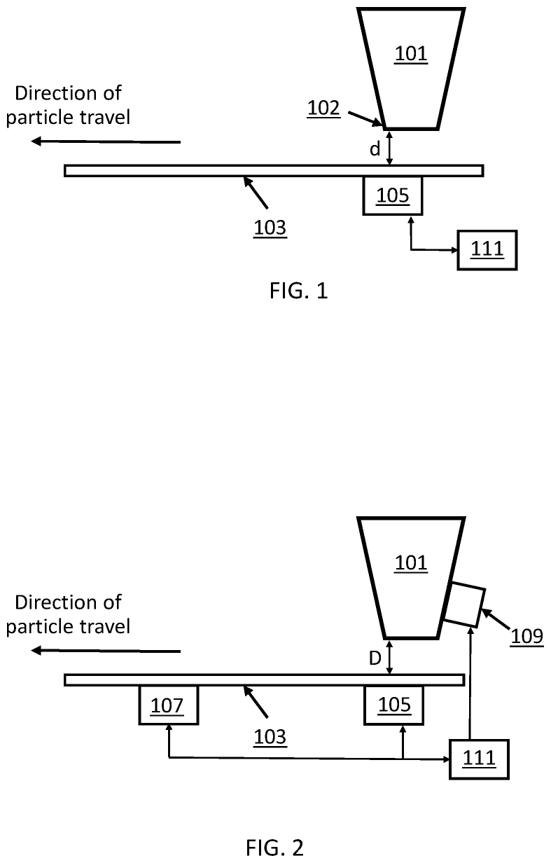

FIG. 1 shows an example system for dispensing particles, according to one embodiment of the present disclosure. In this embodiment, the system includes a hopper 101, which has a hopper outlet 102 which is offset a distance d from a vibrating surface 103. In some embodiments, the vibrating surface 103 may include a channel or chute, and can be mechanically connected to a mechanical vibrator 105 or vibrating motor. The mechanical vibrator 105 can be secured to the vibrating surface using a bracket system, in some embodiments, or some other type of mechanical fastener. The mechanical vibrator 105 may be in communication with a controller 111 that can induce the mechanical vibrator 105 to generate vibrations of different amplitude, frequency, and duration.

In some embodiments, the feed rate of the particles dispensed from the system can be controlled by the frequency f and amplitude A of the vibrations, as well as the opening diameter of the hopper outlet 102 and the offset distance d from the vibrating surface. According to some embodiments, the mechanical vibrator 105 can generate a baseline vibration at a baseline amplitude, as well as a number of periodic amplitude pulses. This can facilitate flow of relatively small particles, such as powders down to about 5 microns or smaller; as well as the flow of sticky materials such as small-particle battery cathode materials.

In some embodiments, the pulsed control of the mechanical vibrator can prevent bridging (where particles form a bridge or arch and block the hopper outlet) or rat-holing (where stationary particles collect near the mouth of the hopper outlet and particles only flow through a narrow channel) of particles at the hopper outlet. Such vibration pulses can effectively knock powder off the inner walls of the hopper to prevent such phenomena.

In some embodiments, the mechanical vibrator 105 is solated from the hopper 101 in order to prevent or avoid further particle compaction. In such an embodiment, the vibrations from the mechanical vibrator 105 can transfer from the particles in the tray or vibrating surface 103 to the material in the hopper through the material medium itself. Thus, in some embodiments vibrations can be transferred from the vibrating surface 103 to the material within the hopper without directly mechanically vibrating the hopper itself.

FIG. 2 shows another example system for dispensing particles, according to one embodiment of the present disclosure. In this embodiment, the system includes a hopper 101, which has a hopper outlet 102 which is offset a distance d from a vibrating surface 103. Compared to the embodiment shown in FIG. 1, the embodiment of FIG. 2 includes a mechanical vibrator 109 connected to the hopper 101, as well as mechanical vibrators 105 and 107 connected to the vibrating surface 103. Such an arrangement may be useful for generating vibration pulses at the hopper itself, or along the length of the vibrating surface. The mechanical vibrators 105, 107, 109 can be secured using a bracket system, in some embodiments, or some other type of mechanical fastener. The mechanical vibrators 105, 107, 109 may all be in communication with a controller 111, in some embodiments, in order to generate vibrations of different amplitude, frequency, and duration at the various components of the system.

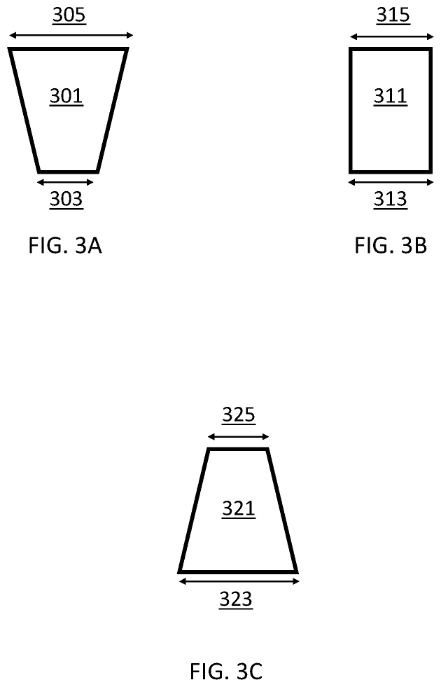

FIGS. 3A-3C show cross sectional views of example hopper geometries, according to one embodiment of the present disclosure. FIG. 3A shows an example hopper 301 having an inlet opening 305 that is larger than the outlet opening 303. FIG. 3B shows an example hopper 311 having an inlet opening 315 that is substantially equal to the outlet opening 313, where the sidewalls of the hopper 311 are generally parallel. FIG. 3C shows an example hopper 321 having an inlet opening 325 that is smaller than the outlet opening 323.

While a hopper designed as shown in FIG. 3A can be implemented according to certain embodiments of the present disclosure, the hopper shown in FIG. 3C with an inverted design promoted passive downward particle flow and was never subject to bridging or rat-holing. However, re-loading of the inverted designed hopper may be challenging. Thus, the vertical or parallel design shown in FIG. 3B can provide a successful balance between usability and performance.

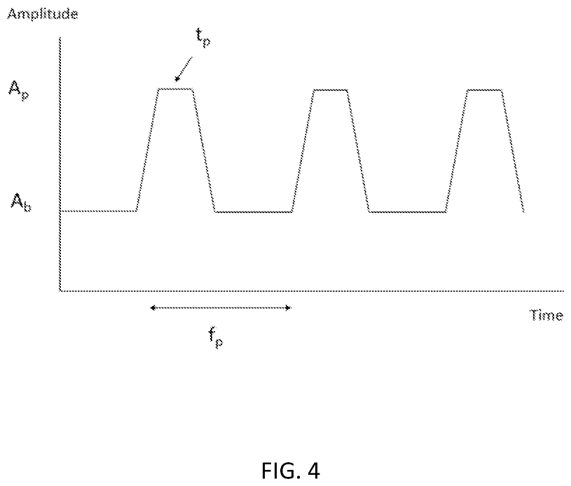

FIG. 4 is a graph of example vibration spikes, according to one embodiment of the present disclosure. In this embodiment, the mechanical vibrator(s) generate a baseline vibration having a baseline amplitude Ab, and periodically generate a vibration amplitude spike or pulse having a pulse amplitude Ap, and a duration tp. This periodic vibration spike or pulse can be tenerated at a particular frequency fp, and between spikes the baseline amplitude vibrations can resume. Such periodic, high-amplitude spikes throughout a run can effectively knock powder off the inner walls of the hopper, and keep the vibrating surface whetted, while being short enough to not disrupt the overall material feed rate of the system. Thus, the overall feed rate of the system can be effectively controlled using the baseline amplitude Ap, which can vary depending on the type of particles, shape of particles, size of particles, etc.

The various characteristics of the vibration pulse can also depend on the type, size, shape, etc. of the particles being dispensed. For example, in some embodiments a particular baseline amplitude, pulse amplitude, pulse duration, and pulse frequency can be determined for dispensing a first quantity of particles. Once those particles have been dispensed, the system can be loaded with a different quantity of particles having different size, shape, friction coefficient, etc., and the system can determine another baseline amplitude, pulse amplitude, pulse duration, and pulse frequency for this new material. This allows for a customized vibration scheme for different materials in order to maximize flow through a system without the need to adjust any particular hardware elements. Such a system can also be equipped with an existing hardware platform (i.e. a passive hopper and vibrating tray), and does not necessarily require any additional mechanical means of agitation to mitigate bridging (e.g., a screw, impactor, agitator, etc.).

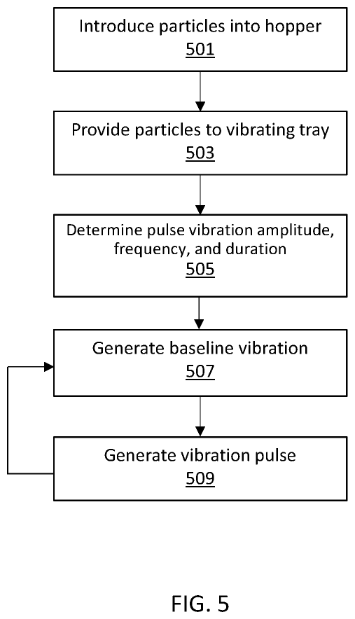

FIG. 5 is a flow chart illustrating a method of dispensing particles, according to one embodiment of the present disclosure. At operation 501, particles are introduced into the hopper. The hopper can include, for example, various different geometries. In some embodiments, the sidewalls of the hopper can be generally parallel, while in other emboidments the opening at the hopper inlet can be larger or smaller than the opening at the hopper outlet.

At operation 503, the particles can be provided to a vibrating tray from the hopper. As discussed above, the tray can be connected to or mechanically attached to a mechanical vibrator in order to generate vibrations of different amplitude.

At operation 505, a pulse vibration amplitude, frequency, and duration are determined. These characteristics of the vibration pulse can depend, in some embodiments, on the type of particles being dispensed, the size or geometry of the particles being dispensed, the coefficient of friction of the particles being disepensed, etc.

At operation 507, a baseline vibration is generated having a baseline amplitude. The baseline amplitude can depend, for example, on the type or size of the particles being dispensed from the system. In some embodiments, the mechanical vibrator can be in communication with a controller in order to control the parameters of the vibrations being exerted on the system.

At operation 509, the vibration pulse is generated in order to enhance particle flow and prevent bridging or rat-holing. In some emboidments, the vibration pulse is short enough to not significantly impact the overall flow rate of the particles through the system. Once the vibration pulse is generated for the desired time period, the baseline vibration may resume at operation 507.

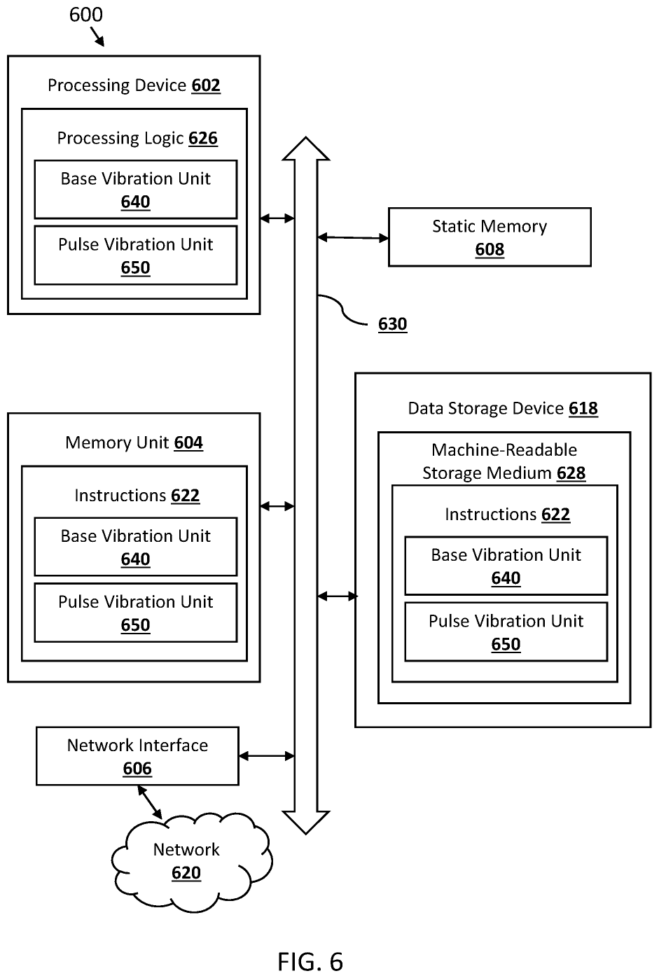

FIG. 6 is a block diagram of an example computer system 600 that may perform one or more of the operations described herein, according to one embodiment of the present disclosure. In this example, the computer system 600 may include a set of instructions, for causing the machine to perform any one or more of the methodologies discussed herein. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device 602, a main memory unit 604 (e.g., read-only memory (ROM), flash memory, dynamic random-access memory (DRAM), a static memory 608 (e.g., flash memory, static random access memory (SRAM), etc.), and a data storage device 618, which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

In this embodiment, the processing device 602 represents one or more general-purpose processing devices such as a microprocessor, central processing unit, or the like. Processing device 602 may also be one or more special-purpose processing devices such as an application specific integrated circuit (ASIC), a field programmable gate array (FPGA), a digital signal processor (DSP), network processor, or the like.

The processing device 602 can be configured to execute processing logic 626, which may be one example of a base vibration unit 640 for determining a baseline vibration, or a pulse vibration unit 650 for determining a vibration pulse amplitude, duration, and frequency, as discussed herein.

The data storage device 618 may include a machine-readable storage medium 628, on which is stored one or more set of instructions 622 (e.g., software) embodying any one or more of the methodologies of functions described herein, including instructions to cause the processing device 602 to execute the base vibration unit 640 for determining a baseline vibration, or a pulse vibration unit 650 for determining a vibration pulse amplitude, duration, and frequency. The instructions 622 may also reside, completely or at least partially, within the main memory 604 or within the processing device 602 during execution thereof by the computer system 600; the main memory 604 and the processing device 602 also constituting machine-readable storage media. The instructions 622 may further be transmitted or received over a network 620 via the network interface device 606.

While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

What is claimed is:

1. A pulsed control vibratory particle hopper, comprising:
a particle hopper having a hopper outlet with a parallel geometry, wherein the sidewalls of the hopper outlet have a cross sectional geometry that is substantially parallel;
a vibrating tray to receive particles from the hopper outlet;
a mechanical vibrator mechanically connected to the vibrating tray to generate a baseline vibration, as well as a periodic vibration amplitude spike;
a controller in communication with the mechanical vibrator to control the mechanical vibrator to generate the periodic vibration amplitude spike having a duration Tp, a maximum amplitude Ap, and a frequency Fp, wherein the duration Tp, maximum amplitude Ap, and frequency Fp are determined based on a size or a type of a material being dispensed from the particle hopper.

2. The pulsed control vibratory particle hopper of claim 1, wherein the controller is programmed to generate a different periodic vibration amplitude spike when different materials are being dispensed.

3. A particle feeding system, comprising:
a particle hopper having a hopper outlet;
a vibrating tray to receive a material from the hopper outlet;
a mechanical vibrator to generate a vibration at a particular frequency and amplitude;
a controller in communication with the mechanical vibrator to control the mechanical vibrator to generate periodic vibration amplitude spikes depending on one or more properties of the material being dispensed from the particle feeding system.

4. The particle feeding system of claim 3, wherein the hopper outlet has an inverted cross sectional geometry that increases in size toward an exit end of the hopper outlet.

5. The particle feeding system of claim 3, wherein the hopper outlet has a parallel cross sectional geometry with parallel sidewalls.

6. The particle feeding system of claim 3, wherein the material being dispensed from the particle feeding system includes particles having a diameter of about 5 microns or smaller.

7. The particle feeding system of claim 3, wherein the material being dispensed from the particle feeding system includes NMC battery cathode materials.

8. The particle feeding system of claim 3, wherein the controller causes the mechanical vibrator to generate periodic vibration amplitude spikes having a duration Tp depending on a size or a type of the material being dispensed from the particle feeding system.

9. The particle feeding system of claim 8, wherein the duration Tp of the periodic vibration amplitude spikes do not disrupt overall material feed rate.

10. The particle feeding system of claim 3, wherein the controller causes the mechanical vibrator to generate periodic vibration amplitude spikes having a maximum amplitude Ap and a frequency Fp depending on a size or a type of the material being dispensed from the particle feeding system.

11. A method for feeding particles, comprising:
introducing particles into a particle hopper having a hopper outlet;
providing the particles from the hopper outlet to a vibrating tray;
generating a vibration at the vibrating tray at a particular frequency and amplitude using a mechanical vibrator; and
generating periodic vibration amplitude spikes depending on one or more properties of a material being dispensed from the particle feeding system.

12. The method of claim 11, wherein the hopper outlet has an inverted cross sectional geometry that increases in size toward an exit end of the hopper outlet.

13. The method of claim 11, wherein the hopper outlet has a parallel cross sectional geometry with parallel sidewalls.

14. The method of claim 11, wherein the particles introduced into the particle hopper have a diameter of about 5 microns or smaller.

15. The method of claim 11, wherein the particles introduced into the particle hopper include NMC battery cathode materials.

16. The method of claim 11, wherein the periodic vibration amplitude spikes have a duration Tp depending on a size or a type of the material being dispensed from the particle feeding system.

17. The method of claim 16, wherein the duration Tp of the periodic vibration amplitude spikes do not disrupt overall material feed rate.

18. The method of claim 11, wherein the periodic vibration amplitude spikes have a maximum amplitude Ap and a frequency Fp depending on a size or a type of the material being dispensed from the particle feeding system.

19. The method of claim 11, further comprising providing the material being dispensed from the particle feeding system to a jet mill for further processing.

20. The method of claim 11, further comprising providing the material being dispensed from the particle feeding system to a plasma torch for further processing.
